(19) United States
(12) Patent Application Publication
(10) Pub. No.: US 2022/0019186 A1
(43) Pub. Date: Jan. 20, 2022

(54) METHOD AND SYSTEM FOR SMART ENVIRONMENT MANAGEMENT

(71) Applicant: MOKA MIND SOFTWARE LTDA, São Paulo (BR)

(72) Inventors: Ricardo Trentin DE ANDRADE, São Paulo (BR); Ahmed Ali Abdalla ESMIN, São Paulo (BR)

(21) Appl. No.: 17/311,612

(22) PCT Filed: Dec. 9, 2019
(86) PCT No.: PCT/BR2019/050527

§ 371 Date: Jun. 7, 2021

(30) Foreign Application Priority Data
Dec. 7, 2018 (BR) BR1020180754459

(51) Int. Cl. G05B 19/042; G06K 7/10

(52) U.S. Cl. CPC G05B 19/042; G05B 2219/2614; G06K 7/10366

(57) ABSTRACT

It describes an intelligent environment management process and system based on Internet of Things (IoT) technology, Cloud Computing, and the application of Artificial Intelligence (AI) and Machine Learning (ML) techniques aimed at providing an environment adapted to its real use in a customized way, which will bring countless benefits to users with a more intelligent use of the environment's features based on actions and suggestions from data collection and pre-processing; Processing and Application of Artificial Intelligence (AI) Strategies in the Cloud and User Interface. The invention thus provides intelligent, adaptive management for greater comfort, in addition to automatically measuring, analyzing, and acting on the environments' comfort and efficiency based on the preferences of their users and managers.

### TECHNICAL FIELD

The present invention concerns a process and a system for intelligent management of environments based on the Internet of Things (IoT) technology. More specifically, the present invention concerns a process and an intelligent management system for environments based on IoT sensoring and the application of cloud computing artificial intelligence models.

### PRIOR ART

First, it's necessary to go back to the beginning of commercial building control systems in Brazil and, then, to the onset of residential control systems to understand IoT/cloud computing-related issues, The automated control for commercial buildings followed in the footsteps of industrial controls and with its kickoff taking place in Brazil in the 1980s. The automated residential control, on the other hand, followed in the footsteps of commercial buildings control with its kickoff taking place in Brazil in the 1990s.

Back in the day, the commercial building automated control focused on the control of pieces of equipment such as air conditioning and lighting systems based on local controllers using low-level programming languages, such as ASSEMBLER, and electric actuators such as contactors and bistable switches. With the evolution of local data network development, the man-machine interface (MMIS) was integrated into control processes, thereby allowing for centralized visualization and control of different pieces of equipment, This evolution made it possible for the creation of the first versions of what we know today as Building Management System (BMS) or Building Automation System (BAS), which are systems used for controlling, visualizing, and programming automated building routines that allow for the management of systems like air conditioning, lighting, CCTV control and access, sound, and water supply. By the end of the 1990s, the control and supervision of commercial buildings were chiefly carried out locally by these systems. World-renowned companies, such as Johnson Controls and Honeywell, developed BMSs for the complete management of commercial buildings that are important players in the automation market.

Although some control centers were already being used before the year 2000, the evolution of the Internet connection and WAN networks made it possible to disseminate these centers that were responsible for the control and visualization of a number of buildings. As a result of such evolution, software licenses started being offered to access local supervisory systems via the Web (the so-called web access licenses) with which one could have total or partial access to local IHM using Internet-connected external computers. This format evolved into the remote access to local IHM via cell phones (the so-called mobile access), which is widely used today.

With the advent of the aforementioned formats, the protection of local commercial building networks based on firewalls became necessary due to the vulnerability to which the data generated by local commercial building networks were exposed while being transmitted via the Internet. The responsibility for parameterization/maintenance of firewalls between IT and AT networks is still a point of contention among different Information Technology (IT) and Automation Technology (AT) teams.

It turned out that hackers, viruses, malware, and so on, have always focused on corporate systems, with TA not being hit by such threats until specific malware had been created to attack industrial equipment, as was the case of STUXNET that, in 2010, attacked pieces of equipment, such as PLCs manufactured by SIEMENS in different parts of the world, causing serious failures in important industrial systems, mainly in hydroelectric and thermal power plants.

The discussion regarding the issue of information security in the current decade has gained momentum and, with the emergence of Cloud Computing, a new approach to the development of systems outside firewalls was brought forth and, along with Cloud Computing, also the development of telecommunication networks capable of connecting (almost) everything in the world—using customized communication bandwidths—to certain types of sensors, and, furthermore, due to the necessary reliability and available funding, it favored the emergence of IoT that makes it possible for a direct connection between local sensors and the cloud. With the emergence of the concept of Cloud Computing, those information security issues took on a new format, thereby giving birth to new paradigms regarding the protection of a huge volume of data “in the hands” of a small number of companies.

In this scenario, cloud-based service platforms that provide pre-programmed services for the implementation of other cloud- and subcloud-based specific services that emerged early on in the current decade, such as AWS, GCP, Bluemix, and Azure, picked up steam. It was in such a context that systems designed to handle information from specific processes began to be made available (in such industries as plants, transport, commerce, finance, health, infrastructure, and education), including the direct collection of data from local sensors and cloud processing.

Now lets move from the development of automated systems for the control of commercial buildings whose evolution has already been considered—since the time when local controls were used behind a firewall up to when more advanced systems were recently introduced, based on IoT and Cloud Computing—in order to get a deeper knowledge of the development of Artificial Intelligence (AI) systems.

The term ‘Artificial Intelligence’ emerged in the U.S. in the 1950s aimed at demonstrating that, if certain processes could be clearly described and detailed, they could also be run by machines and no longer by humans. This term was chosen for its neutrality in relation to another mainstream technology at the time, the so-called ‘thinking machines’ that included concepts such as cybernetics and complex information processing, which were not dealt with by AI at that time. Today, AI is defined as a field of computer science that has been broken down into three parts: Strong AI, focused on imitating human behavior in a given process; Weak AI, focused on carrying out a job in a given process without considering how that same job would be performed by humans; and human-centered AI used in executing a job in a given process but not focusing on imitating human behavior as its ultimate objective.

Our focus will be on the third part, which seems to be the trend in implementation of AI in the industrial sector and, as a result, in the commercial building market.

Following the development of computational processing and the concentration of huge amounts of data (Big Data), a world of opportunities opened up for the implementation of new models of AI, mostly in recent years and mainly now with the advancement of new systems for voice recognition, human behavior standards recognition, recognition of fluctuations in the finance market, diagnoses and prognostics in general (legal, medical, etc.), and machine and deep learning, which is an AI subarea.

In addition to the issues related to IoT/cloud computing and AI, and given the subjectivity that characterizes the term ‘comfort’, the psychological issues that influence the feeling of comfort as experienced by people should also be considered. O Frederick Herzberg (1923-2000) developed the motivation-hygiene theory through which he demonstrated how the employees of a given company can be influenced by motivational and other factors that he classified as hygiene factors. The term ‘hygiene’ was taken from the medical sector and refers mainly to prevention. Motivational factors shall not be worked out in detail here as they basically refer to someone's sense of achievement. Hygiene factors however—the ones that interest the most for now—refer to someone's workplace environment. According to Herzberg's study, if a given hygiene factor in the environment meets or exceeds the requirements of the people that use the environment, this factor itself doesn't generate an additional perceived sense of satisfaction, that is to say, this factor only accomplished its mission. On the other hand, if the factor doesn't meet the requirements of the people that use the environment, the sense of dissatisfaction is greatly perceived by the people in that environment, that is to say, if a given hygiene factor fails to meet minimal requirements for the satisfaction of the people using the environment, it will cause a great level of dissatisfaction in these people. Air conditioning and lighting systems are considered hygiene factors. This explains the immense importance of always using updated techniques to monitor and control these systems.

Studies have pointed to a steady advancement of works in IoT/Cloud Computing and AI areas designed for both the commercial and residential building market, for example:

Patent document BR 10 2016 023243-0 concerns a communication module for air conditioning units, whose performance is carried out from local wireless IoT sensing and MESH networks, which detect the environment's internal and external temperature and humidity. The control module then uses the data and acts directly on the air conditioning units, automatically regulating the temperature in view of the comfort goals set by the users.

Despite the proven savings generated in the proof of concept presented above, the creation of an air conditioning control module raises doubts about the scale's applicability as it pertains to this solution. Its well-known that air conditioning units represent more than 70% of the total investment in complete air conditioning systems, considering the design, installation, automation system, accessories, and the air conditioning units themselves. Thus, if the air conditioning unit is still within its life cycle, it's difficult, if not impossible, to replace it with one capable of receiving external commands adapted to a specific standardized control module. Therefore, the equipment's remote control needs to be adapted so that it can pick up external commands generated from a module different from the one provided for in its original manufacture or the air conditioning unit itself has be adapted. In this regard, as explained, either the air conditioning unit is adapted, which can result in its malfunctioning and even the loss of its warranty, if the equipment manufacturer is not involved in this intervention, or the control module, object of the referred document BR 10 2016 023243-0, is adapted for this specific piece of equipment. Given the diversity of air conditioning units in the domestic market, this option would result in the need to develop numerous control modules adapted to each type of air conditioning equipment, which justifiably questions the financial feasibility of implementation on such a large scale.

Additionally, already established concepts of thermal control had apparently been applied here, with no identifiable AI technique having been applied.

Patent document CN 102004482 A describes an automatic energy-saving building system based on IoT, which integrates local sensing from a TCP/IP and RFID data network and uses high-capacity internet. Data collection is carried out from the RFID identification of equipment and wearables on the individuals occupying a given building. Based on the people occupying the environments, as identified by RFID sensors, and the traditional sensing of temperature, humidity, and electric measurement, PLCs control the lighting and thermal comfort provided by the air conditioning equipment.

The integration of traditional controls adapted through real-time sensing of the occupation of the environment based on RFID sensing makes it possible to use controls that are more adaptive to the environments due to the precise interpretation of how the people occupying the environment are positioned. However, the possibility of precisely identifying the position of individuals in the environment only confers energy-saving advantages if the actuators in both lighting and air conditioning are proportionally capable of focusing their action where said individuals are located. The result is a noticeably greater investment in air conditioning actuators and individualized lighting systems, which substantially increases the investment in building instrumentation. Should this investment not be financially feasible, working through the building's lighting and air conditioning systems becomes an option, which traditionally happens in numerous buildings around the world. In this case, RFID sensing becomes useless, since presence sensing at the entrance of the environments (much cheaper than said RFID sensing) has the same results when it comes to controlling lighting and temperature since the actuators have the ability to act exclusively by building area (i.e., A side of the building, quadrant 3 of the building, and so forth).

Patent document US 200710138307 A1 describes a method and apparatus for determining a command that controls a device in a heating, ventilation, and air conditioning (HVAC) support system. A range of comfort values is entered by the environments occupants who want it to be air conditioned. A database of rules leads to values of the related comfort, with one or more rules being applied to yield diffuse results. This result is then defuzzied so as to obtain a crisp command value from the device.

The above-referenced document deals with a specific method that uses an artificial intelligence technique (fuzzy logic) to generate a better-adjusted control by plugging in feedback values provided by the environments occupants to control the device by mapping the values to a command value. Although the application deals with comfort environments, the proposed method deals with a very specific situation, in which all users can give feedback and the system, and the device must then find the best values.

Patent document US 2016/0305678 A1 describes a method for controlling the temperature in a thermal zone within a building, which comprises: receiving a desired temperature range in the thermal zone through a processor; and using a predictive model for the building, determining set points for a heating, ventilation, and air conditioning system (HVAC), which is associated with the thermal zone that minimizes the building's energy use. The desired temperature range and predicted ambient temperature value are entered into the predictive model. This predictive model is trained using historical data of measured values for at least one of those inputs; and controlling the HVAC system with set points to maintain the actual temperature value of the thermal zone within the desired temperature range.

The above-proposed system makes a prediction of the building's temperature considering the need to maintain the environment within a comfort zone, as well as energy consumption by controlling the HVAC system with set points. This system handles a specific context through an HVAC system with set points and doesn't take the dynamic environment or IoT technologies into account.

Patent Document US 2017/0241663 A1 describes related computer program devices, systems, methods, and products for managing demand-response programs and events. The disclosed systems include an energy management system working with an intelligent thermostat connected to the network and located in a given structure. The thermostat controls an HVAC system designed to cool the structure using a demand response event implementation profile. The thermostat can also receive a requested change in the setpoint temperatures defined by the demand response event implementation profile and access to the determination of an impact on the energy change that would result should the requested change be incorporated in the demand response event implementation profile. This determination can be communicated to the energy consumer.

As shown in the above document, and judging from the extensive search carried out in the field of intelligent management of environments based on AI and the Internet of Things (IoT) technology up to now, it remains clear that the previous technique fails to describe a system that collects sensing data via IoT and processes it via Cloud Computing, generating specific text and voice insights, and outlining dynamic user and environment profiles, causing them both to interact with each other through AI models.

Therefore, there is a need for improvement based on two pillars that guide the present invention, namely, the Internet of Things (IoT)/Cloud Computing or Cloud Computing and Artificial Intelligence (AI).

### SUMMARY OF THE INVENTION

The terms related to the word “invention” used in this description are intended to refer broadly to all matters in the document, including the specification, claims, and drawings. Statements containing such terms are to be understood either as not limiting the matter described in this document or limiting the meaning or scope of the claims below. The embodiments of the invention covered by this description are defined by the claims below. This summary gives a high-level overview of various aspects of the invention and introduces some concepts that are further described in the “Detailed Description” section below. The summary is not meant to be and should not be used in isolation to determine the scope of the subject matter of the invention. This material should be understood, by way of reference, to appropriate parts of the specification, any or all drawings, and each claim.

The present invention refers to the process of intelligent environment management and aims to assess the users' comfort level within the environment and classify the environments based on the summary of users' comforts. This classification is called the adherence level, with there being a user adherence level and the environment adherence level.

Where adherence levels are the results of interactions between dynamic user profiles and dynamic environment profiles. In other words, the user's adherence level refers to how comfortable each user is in a given environment, and the environment adherence level refers to how comfortable that environment is to all the users occupying it.

Advantageously, the intelligent environment management process proposed herein also includes a description of user and environment comfort indicators based on the calculation of environment adherence to the dynamic user profiles, which are, in turn, based on user preferences related to thermal comfort, lighting level, and occupancy, as well as other parameters from dynamic profile using AI and ML techniques.

The construction and maintenance of the dynamic profile of users and environments (the adherence calculation) is performed according to the instrumentation available in the environment and can be carried out from a single registration data or a combination of two or more, and even new, data that may have new instrumentation available. An AI algorithm is applied to this construction, based on user interaction with the graphic indication scales, which determines the environment's parameterization and classification and its adherence level to the user profiles, which indicates the user's perception of comfort in the environment.

To calculate the dynamic user profiles, it's necessary to collect data from the environments' sensors, registered data from the environments and users, data outside of the environment, and finally let the user interact with the environment through adjustment requests. These data can then be used to calculate a dynamic user profile and a dynamic environment profile.

Advantageously, the intelligent environment management process also includes the construction and maintenance of the dynamic user and environment profiles, which take place through the collection of user registration data and external data and the reading of the environment data by a data collection agent, using the calculation of the user and environment dynamic profiles and applying AI and ML techniques, whose profiles are also dynamically influenced, in general, according to the variation in the user's own feedback to the insights it generates, and specifically to the environment, which is influenced by the dynamic profile of the users occupying it, as well as by the local climate and season, such as autumn, winter, spring or summer, thus forming a closed circuit of user and environment that is mutually influenced; and from the modeling, generation, and recommendation of insights that are induced, created, and adjusted automatically or semi-automatically from AI and ML models to generate a set of rules used in the precondition and condition input, generate messages and insights, and control actions for the user(s) and environment(s), which are capable of being manually or automatically answered by the user, according to his or her profile and that of the environment.

Thus, once the adherence levels have been defined, it's then possible to generate insights for users with information that has already been processed regarding the user and environment comfort levels. In addition to triggering insights, the interaction between user and environment allows the system to act manually or automatically in the environment, so as to always find the best adherence level for both the user and the environment. There's also interaction through a graphic user interface so that one can view and monitor the adherence levels, equipment status, environment data, and interface for users to request comfort adjustments and start the process over again.

Advantageously, the intelligent environment management process also describes the user interaction being carried out using an interface assembled with graphic elements on which images represent data and information; and available tasks are handled directly by the user through applications on mobile phones, wearables, smart speakers and home assistants, smart devices, smart home, laptops, desktop computers, tablets, through graphic screens, text messages, voice, and video.

The present invention also relates to an intelligent environment management system, comprising:

A cloud data processor that executes the MIA ENVIRONMENTAL ADHESION LEVEL AND USERS WITH DYNAMIC PROFILES, which implements the user(s) and environment(s) comfort indicators with the parameterization and classification of the user preferences regarding thermal comfort, lighting level, and occupancy, based on the application of AI and ML techniques and user interaction with graphic scales indicators that determine the parameterization of the referred environment and the adherence level of its users, which indicates the users' perception of comfort in the environment.

Advantageously, the cloud data processor is based on the processing and application of AI and ML strategies, such as Decision Tree, SVM, KNN, Random Forests, Regression Techniques, Genetic Algorithms, Bio-Inspired Techniques, Artificial Neural Networks, and Fuzzy Logic, as well as NLP techniques, to generate artificial intelligent models (AIMs) to be used in the precondition and condition input, in the generation of goals and insights, and also in the adjustments of factors, weight, and degree of relevance to calculate the adherence level, classify and predict the environment's comfort levels.

To calculate the environments' dynamic profiles, data need to be collected from sensors installed in an IoT data collection station, which allows it to be sent through some communication protocol or any other method of sending data to the cloud. Collection of external environment data is done on the cloud server using APIs. For registered data and interaction with the environment, the user has access to registration and interaction interfaces that are described in greater detail below.

Advantageously, the process makes it possible to execute commands to turn air conditioning and lighting on and off and send the temperature SETPOINT to the air conditioning equipment, which is done remotely or manually by user action, automatically by hourly ON/OFF programming, or as a result of AIMs, purposed with maintaining the best level of user and environment adherence, thus automatically adjusting the set point.

Advantageously, the user interface comprises an interaction system through a dashboard accessed via WEB for commands, visualization of adherence levels, the state of equipment and systems, and the receipt of insights with visualization of results from images, graphics, text, and voice, according to the user-defined parameterization.

Advantageously, the user interface comprises an interaction system through an APP Mobile application, installed on users' smartphones from cloud stores, such as PlayStore and AppleStore, for commands, visualization of adherence levels, equipment and systems status, and receipt of insights with visualization of results from images, graphics, text, and voice, according to the parameterization defined by the user or others.

### BRIEF DESCRIPTION OF THE DRAWINGS

The illustrative, but not limiting, modalities of the present disclosure are described in more detail with reference to the figures below:

FIG. 1 shows the general architecture according to a preferred embodiment of the invention;

FIG. 2 shows some of the main screens of the mobile application according to the invention;

FIG. 3 shows a processing overview and application of cloud AI strategies for selecting insights and the user dynamic profile generating and environment according to the invention;

FIG. 4 shows a process of assembling and updating the user's dynamic profile according to the invention;

FIG. 5A shows a graph that represents both the user and environment dynamic profile according to the invention;

FIG. 5B shows a graph that represents the adherence level between the environment and users according to the invention;

FIG. 5C shows a process of modeling and assembling a dynamic environment profile according to the invention;

FIG. 6 shows a process of creating insights and ML (AI) models according to the invention;

FIG. 7 shows the process of selecting and recommending insights from AI and ML techniques according to the invention;

FIG. 8 shows a strategy for selecting and recommending the best insights according to the invention;

FIG. 9A shows the distribution of the insights according to their values and classes presented by visualization with two attributes in one embodiment of the invention;

FIG. 9B shows the selection of the s2 insight because it's the closest one to the recommendation according to the preferred embodiment of the invention;

FIGS. 10A, B, C, and show four flowcharts describing the entire process of searching, executing insights, and, finally, processing feedback from the insights according to the invention;

FIG. 11 shows the screen of the mobile application or APP with a command for adjusting the user's temperature and comfort level according to the invention; and

FIGS. 12A-E show graphs of the pertinence functions of (A) comfort of users of the environment, (B) user feedback, (C) suggested temperature variation, (D) output from the activation of the pertinence functions, and (E) result with the aggregation of the pertinence functions according to the invention

### DETAILED DESCRIPTION OF THE INVENTION

Some advantageous and optional embodiments for executing the present invention will be described below. This description should not be interpreted as requiring any particular order or arrangement among one or more of the various elements.

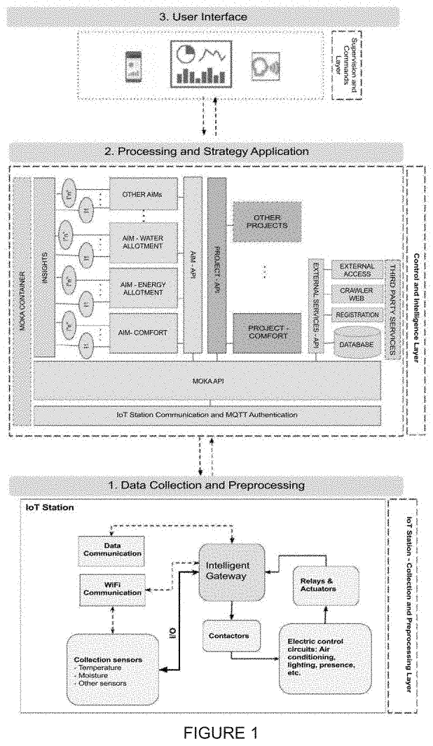

FIG. 1 shows the general architecture according to a preferred embodiment of the invention and is characterized by a cycle that starts with the following steps: data collection and pre-processing; processing and applying strategies; and, interfacing with the user interface.

A data collection agent installed in an IoT station is configured to collect, prepare, pre-process, and filter the local sensing data for transmission to the cloud. Such data collection is carried out in real time from the IoT station, which connects to local sensing by means of discrete signals in current, voltage, wireless, WiFi, local physical data network, data entry by the user through cell phones, wearables, smart speakers and home assistants, computers, laptops, tablets, and so forth. Said local sensor connection is not limited by the type of sensing and can be integrated with temperature, humidity, electrical energy measurement (current, voltage, power, energy quality, power factor, etc.), presence sensors, photo, video, voice recognition, facial recognition, and iris recognition sensors. The limitation is due to the number of sensors per IoT station, which is circumvented by adding more IoT stations. Additionally, the said IoT station can be implemented by using the hardware of different manufacturers, adding collection data processing services developed by Moka Mind, which are connected to the processing services and application of Artificial Intelligence Cloud strategies, also developed by Moka Mind. Data pre-processing carried out by the data collection agent also takes place at the IoT station and is purposed with preparing/filtering the local sensing data for transmission to the cloud. This task prevents the transmission of repeated data, dead bands, etc. which saves on transmission data in telecommunications and cloud storage.

Next, there is the processing and application of Artificial Intelligence strategies in the cloud using a set of cloud services that implement machine learning techniques, including a decision tree and artificial neural networks, creating trained and integrated models that calculate, classify, and predict the comfort levels of the environment, with the aim of generating insights and creating the dynamic user and environment profiles. This step will be described in more detail further on in the present description.

Finally, the user interface was mostly put together with graphic elements on which images represent data and information, and available tasks are handled directly by the user and take place by means of applications on mobile phones, wearables, smart speakers and home assistant, smart devices, smart home, computers, laptops, and tablets through graphic screens, text messages, voice, and video. FIG. 1 presents two different forms of interface for user interaction: 1. The APP Mobile application, installed on users' smartphones from cloud stores, such as PlayStore and AppleStore, and 2. Dashboard accessed through the Web.

As shown in FIG. 1, user interactions for commands and insights are carried out through clicks, touch, and voice commands. The visualization of results and specific insights are presented in text and voice according to the parameterization of this invention.

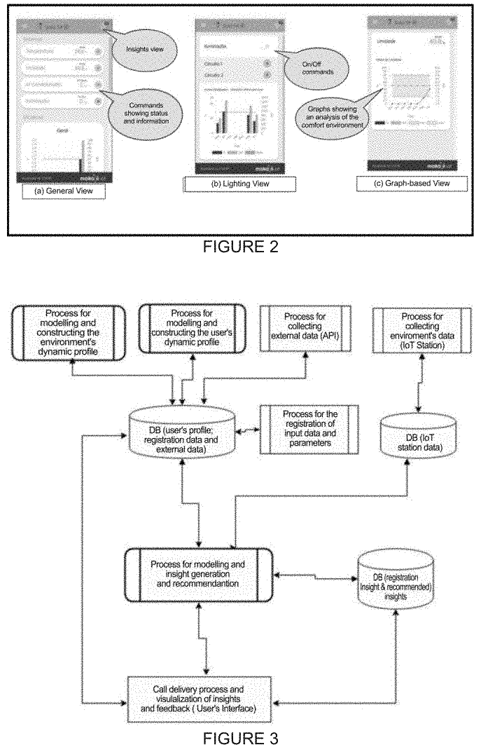

FIG. 2 shows some of the main screens of the mobile application according to the invention with the main functionalities consisting of (a) an overview with data from the sensors, general graphics, and icons for viewing and reading the insights; (b) data screen with lighting with controls for turning circuits on and off and graphs showing hours turned off with targets and variations, among other functions; (c) data screen with humidity read-out and environmental comfort analysis graphs showing the degree of comfort. FIG. 2 shows APP screens with command sequence and insight output.

The present invention suggests and executes ON/OFF commands in the environments, as well as by SET POINTS, analyzes historical data from said environments and compares them with the databases of other cloud systems, correlates environments, accesses other systems for data collection in real time for decision-making, draws conclusions, and presents results aimed at improving the operational efficiency of buildings and houses.

FIG. 3 shows an overview of the processing and application of cloud AI strategies for selecting insights and generating the dynamic user and environment profile, according to the invention. The processing and application of cloud AI strategies take place from a set of cloud services, which implements machine learning techniques, including decision tree and artificial neural networks, thus creating artificial intelligence models that perform the calculation, classification, and prediction of the environment's comfort levels so as to generate insights and create the dynamic user and environment profiles.

To achieve this goal, a strategy is employed in which AI and Machine Learning (ML) techniques are implemented to find and recommend the best insights, as well as create the dynamic user and environment profiles. This strategy comprises three main processes and three auxiliary processes as shown in FIG. 3:

Main Processes

Modeling process and construction of dynamic profile and user adherence level;
Modeling process and construction of environment dynamic profile and adherence level;
Process of modeling, generating, and recommending insights.

Auxiliary Processes

### Registration Process;

### Environment Data Collection Process; and

### External Data Collection Process (Application Programming Interlace [API]).

### Dynamic User Profile Modeling and Construction Process

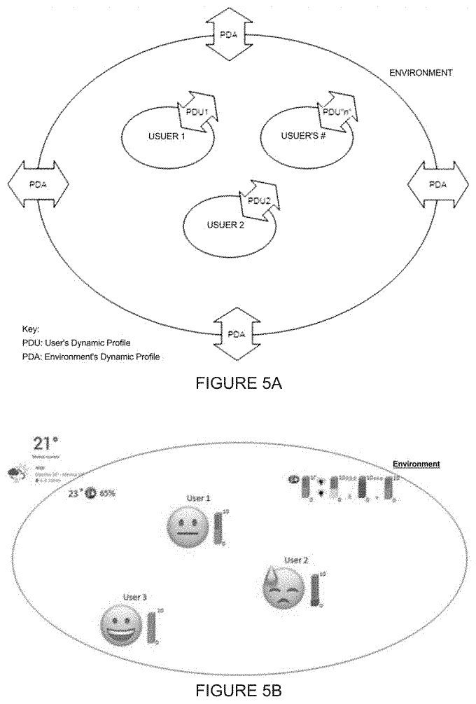

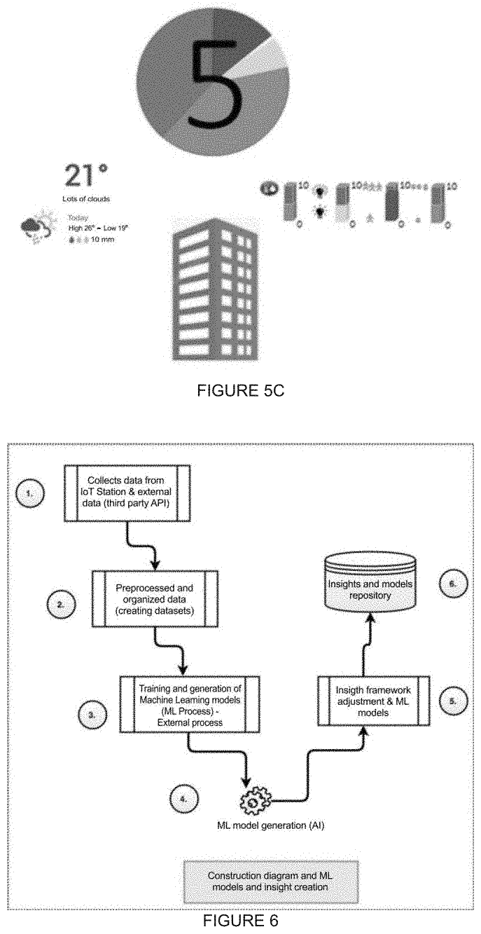

This process is responsible for assembling and maintaining the dynamic user profile for use in a given environment. The profile is assembled based on data from the Registration Process, the Environment Data Collection Process, and the External Data Collection Process. The user profile then dynamically influences the user due to variations in the above-described processes along with the user's own feedback on the insights. Another factor that influences the user's dynamic profile is the environment, which is also dynamic and depends not only on the users dynamic profile but also on the profile of the other users in it, along with external factors (such as the region's climate, and so forth), thus making up a closed system of users and environment that is mutually influenced as shown in FIG. 5A and which will be described further on in greater detail.

As mentioned earlier, the users profile dynamic calculation takes place from the dynamic adjustment of coefficient_factors of each profile, taking into account user and environment classification, using the historical data of the aforementioned processes and a ML technique, such as Artificial Neural Networks (ANN).

In the Artificial Intelligence Model (MIA)—ENVIRONMENT OF COMFORT, the dynamic user profile modeling follows the typical structure below:

### Legend:

defined by=
Field name=field_name:
Values=<value1, value2 . . . >
Example of an environment dynamic profile (EDP):

### -Environment_dynamic_profile:

### Identifier: <EDP_id#01;

type of building: <Building or Industrial Shed>
Type_use <commercial or residential>,
location: <(longitude, latitude), address>,
occupation/m2: <min=5, average=20, max=50>;
time_turn_off_air_day: <min=10, coeficient_factor=13>;
profile_ general_classification: <moderate>;
##registration parameters##;
lighting_turned_off_goal_day; <12>;
hour_planet: <yes>;
lighting_turned_off_goal_day: <10>;
##location data##.

### -User Dynamic Profile:

identifier<UDP_id#01>;
priority: <comfort=70%, savings=30%>;
priority_command: <automatic=60%; manual=40%>;
view_insights_time: <Min=10; average=14; max=20>;
accept_insight: <yes=60%; no=30%; ignore=10%>;
time_turn_off_air: <min=10, coefficient_factor=13>;
temperature_summer_factor: <Min=20; Max=24; coefficient_factor=22>;
temperature_winter_factor: <Min=23; Max=26; coefficient_factor=24>;
preferred_temperature: <Jan=22; Feb=23; . . . Jun=24 . . . Dec=22>;
search_goals: <80%>;
Other registration data and parameters-MokaAPP.

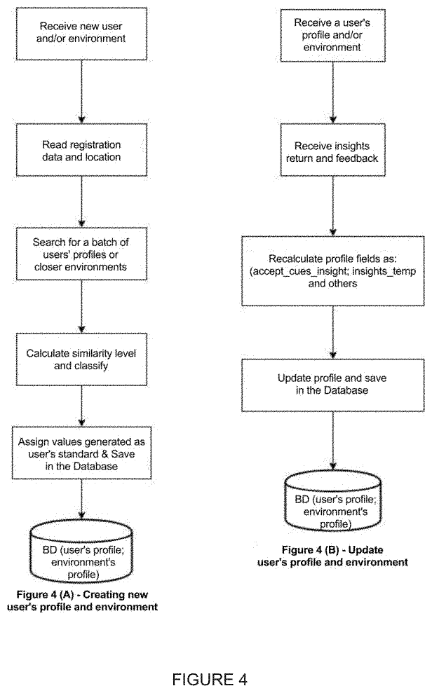

FIG. 4 shows the process through which user profiles are created and kept updated as per the invention for the use of a given environment. The creation of such a profile is based on data from the Registration Process, Data Collection from the Environment Process, and External Data Collection Process. Data from the user's feedback regarding received insights are also used in this process, as well as the use profile of the comfort environment and user's preferences recorded during the registration process. These data are used to calculate the adherence level of the environment and other users, which are classified based on AI techniques,

Dynamic user and environment profiles are created and updated following typical flows, as shown in FIGS. 4 (A) and 4 (B), respectively.

FIG. 5A shows a graph that displays how the dynamic profiles of both users and environment are organized according to the invention; FIG. 5B shows a graph that displays the adherence level between environment and users according to the invention; and FIG. 5C shows a process for modeling and building the environment dynamic profile according to the invention. This process for modeling and building the dynamic profile of the environment is based on the process for modeling and building the user's dynamic profile and depends on at least one user profile associated with the environment, as well as on external factors in relation to the environment, such as the local climate.

### Modeling Process, Dynamic Profile Construction and Generation of Environmental and Efficiency Indicators

This process is responsible for building and updating the dynamic profile of a given environment. The construction of this profile takes place from data from the Registration Process, the Environmental Data Collection Process and the External Data Collection Process. From the construction of the environment profile, it is dynamically influenced due to the variation in the processes described above and also due to the number of dynamic user profiles associated with this environment.

Example 1: an environment with dynamic profiles whose temperature preference is below the environment's current temperature leads to changes in the environment dynamic profile, thereby automatically reducing the temperature of the environment; and

Example 2: should the dynamic profile of a user be changed in relation to a specific parameter, given that another user's dynamic profile has already been changed in relation to the same parameter within a time range lower than what was parameterized in the Registration Process, the related environment profile will be changed to a higher rate than normal in order to allow for a faster response to the indicated tendency.

The environment is then parametrized and classified based on the users' preferences in relation to thermal comfort (adherence level), lighting level, occupancy, and so forth. Graphic scales are generated whose indications visually determine the parameterization and classification of the referred environment. The adherence level of the environment to the dynamic profile of its users is also indicated graphically, thereby indicating the comfort awareness of users in relation to the environment as shown in FIG. 5B.

The aforementioned process is responsible for generating the environment efficiency indicators and classifying them in relation to users' thermal comfort, lighting level, and occupancy, and further to goals that have been parameterized by the user of such environment, with the indication of graphic scales, including tags with indications that visually determine both the parameterization and classification of said environment and its level of adherence to users profiles, which indicates the level efficiency of said environment, as per classification scales shown in FIGS. 5B and 5C.

The sensing system connected to the IoT station (presence sensors, video recognition, geolocation, wearables, and so forth) can dynamically add or delete any user profile and information for a given environment.

The extrapolation of graphic scales of each environment, a graphic classification of the building is generated as illustrated in FIG. 5C.

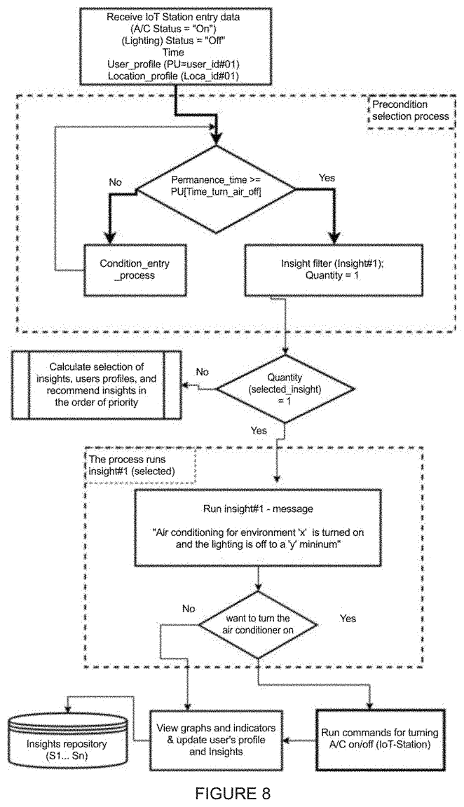

FIG. 8 shows a first example of a strategy for selecting and recommending the best insights according to the invention. The execution of insight#I, from input data from IoT station, user profile and environment in real time aims to determine the degree and classify the comfort environment in Insight#I derived from MIA-COMFORT ENVIRONMENT.

### Description of the Fuzzy Model for Users and Environment Comfort Temperature Adjustment

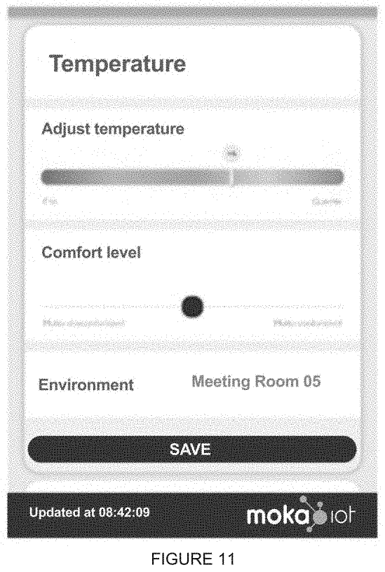

One input is generated based on feedback provided by users who are supposed to select other entries using a comfort sensing selector (see mobile device APP with command for temperature adjustment and user's comfort level in FIG. 11), which are related to the indoor environment temperature provided by the IoT station temperature sensor and environment profile, with the outcome being an adjustment in temperature and comfort for both users and the environment. This model is implemented as one of those services inside the AIM-API architecture.

This model receives a set of parameters pursuant to a given user: Set of last values provided by user's feedback and used to keep the range of comfort updated;

Set of last user feedback values used to keep the comfort range updated;
Comfort temperature of the current environment;
Ambient temperature (read from the IoT station sensor);
Current user feedback with APP input represented by scale from −10 for very cold to 10 for very hot).

Based on these inputs, the fuzzy model is executed and the pertinence functions are activated and, further on, the rules are processed and an output containing the adjustment value is suggested in order to change the comfort temperature for the user and also to adjust the environment comfort.

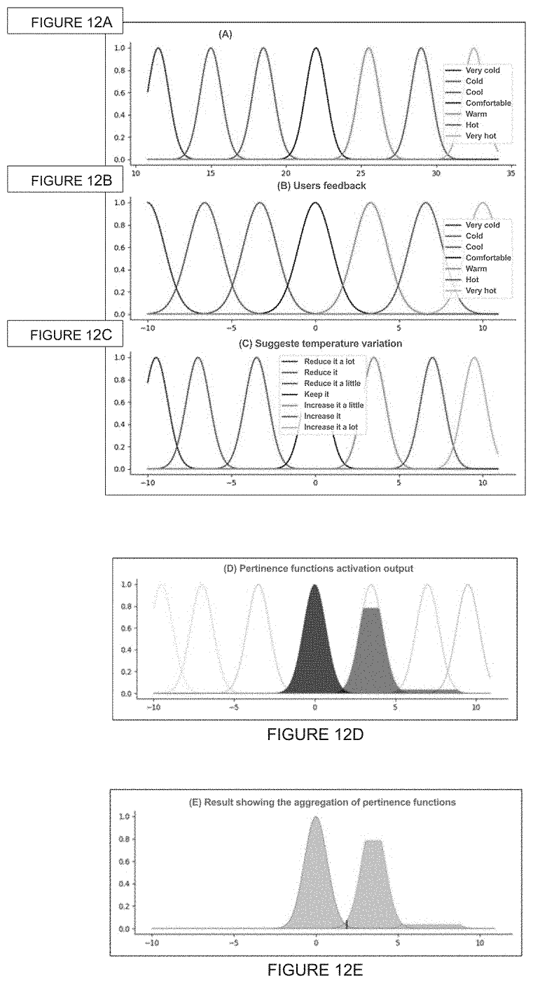

FIGS. 12A, B, and C show the graphs for comfort pertinence functions of the environment users, for the user's feedback and the suggested temperature variation as per the invention, where graph one (see FIG. 12A) shows comfort pertinence functions for the environment users; graph two (see FIG. 12B) shows the user's updated feedback pertinence functions ranging from −50 to 50; graph three (see FIG. 12C) shows the suggested output pertinence functions (for example, variation of the required temperature for adjustments in order to improve user's comfort feeling); graph four (see FIG. 12D) shows which output pertinence functions have been activated by the user's entries, It can also be noticed that, in this specific case, three functions have been activated at different levels. Finally, graph five (see FIG. 12E) illustrates the aggregation of output functions that were activated and the new suggested value.

Specifically with regard to the graphs showed in FIG. 12, the entries were as follows:

Comfort temperature: 22° C.
Environment temperature: 22° C.
User's feedback: −4 (between cold and cool)

It can be noticed in this case that, even if the temperature is equal to a predefined comfort temperature, the users says he/she feels cold. Thus, the suggestion is: Raise the temperature by 1.9° C. (FIG. 12E).

### Registration Process

All of the environment and user characteristics, including their preferences, as well as the parameters for Artificial Intelligence Models (AIMs) are included in this process.

### Environment Data Collection Process

In this process, all real-time data related to the environment are collected through the IoT station.

### External Data Collection Process

In this process, both historical and real-time data are collected from applications such as systems and databases on the Web.

### Modeling, Generation, and Insights Recommendation Process

This process handles the creation, generation, and recommendation of control insights and actions based on the data collected by the IoT station, geographic location, third-party API external auxiliary data, and registration data, and the profile of both user and environment, which are used to generate and recommend insights and control actions.

In order to meet these objectives, insights representation models are defined, and AI techniques are used to generate, find, and recommend best insights. FIG. 6 shows the process for modeling, generating, and recommending insights according to the present invention. FIG. 6 illustrates how this process works.

Insights are described using the following template:

### Legend:

defined by =
Field name=field_name:
Values=<value1, value2 . . . >
Insight template:
insight_identifier: <insight_sole_identifier>.
precondition: <condition based on collected values, set of rules induced by a ML model from data, and other expressions to enter the insights>.
entry_condition: <condition for keeping the same status and wait-time>.
message: <insight text or voice message>.
objective: <description of objectives in text, graph, or other means>.
action_command: <set of actions and commands that can be executed>.
who_generated: <who wrote the insights (person or AI assistant>.
date_generated: <date on which the insights were included>.
return_feedback: <return options (yes, no, ignore)>.
quantity_trigger <number of times it was generated and viewed>.
weight: <weight is calculated based on feedback data and number of times it was generated [0 . . . 1]>.
level_relevance:<insight level of relevance [high, medium, low]>,
Obs. This template can be expanded to accommodate more information and fields.

Insights can be induced, created, and adjusted, either automatically or semi-automatically, based on AI and ML models such as Decision Tree, SVM, KNN, Random Forests, Regression Techniques, Genetic Algorithms, Bio-inspired Techniques, Artificial Neural Networks (ANNs), and Fuzzy Logic, as well as NLP techniques, in order to generate a set of rules that will be used during precondition, condition, entry condition, message generation, and objective, as well as for adjustments among factors, insight weight an level of relevance, in addition to a cluster of actions and commands that must be executed should the insight be accepted.

### MIA Insight Example COMFORT ENVIRONMENT:

insight#1.
identifier: <insight#1>.
pre_condition: <Status(A/C)=On) & (Status(lighting)=Off)>.
entry_condition: <time of permanence>=<“t” minutes [stop]>.
message: <Air conditioning in environment “x” is turned on and lighting has been off for “y” minutes. Would you like to turn the air conditioner off? Would you like to repeat this action in next occurrences?>
objective: <Monitor operation aimed at ensuring savings and cost reduction>
action_command: <turn_off(A/C)>
who_generated: <person>
date_generated: <1.10.2018>
return_feedback: <return options (yes, no, ignore>number triggers: <50>
weight: <0.75>
level_relevance: <High>

### Insights Recommendation

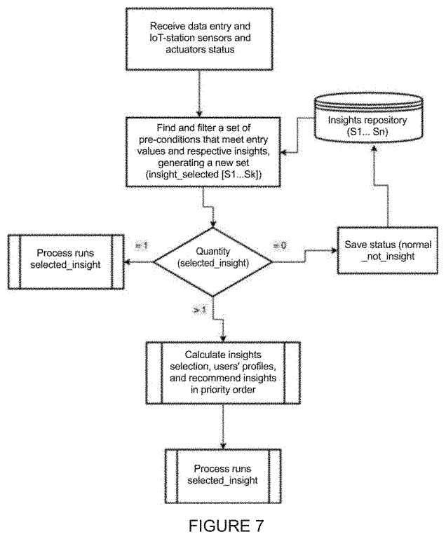

FIG. 7 shows the process of recommending insights using AI and ML techniques, the degree of similarity, and nearest neighbor techniques and further presents an adjustment in the dynamic parameters using AI techniques, such as Genetic Algorithms, for multiple objective optimization.

Given a set of insights (S1 . . . Sn), each with its precondition (PS1 . . . PSm); m<=n, where some insights may have the same precondition; each insight has a weight (W1 . . . Wn), also given a user profile (P) and set of user-profiles (P1 . . . Pn), select and recommend the best, most adapted insights using the following process and steps, which are also shown in the FIG. 7 flowchart (Rec-YYY):

Step 1: Receive data input and status of sensors and actuators from the IoT station;

Step 2: Find and filter a precondition set that satisfies the input values and their insights from (PS1 . . . PSm);

Step 3: If only one insight is found, then carry out the insight steps and go directly to step 5;

Step 4: If more than one insight is found, then the insight selection calculation, user profiles, and insight recommendation are applied in priority order and the insight steps are carried out;

Step 5: Update insight weights and data;

Insight recommendations using AI and ML techniques, degree of similarity, and nearest neighbor techniques, plus the presentation of a dynamic parameter fit using AI techniques, such as Genetic Algorithms, for multiple objective optimization as shown in FIG. 7.

The similarity calculation will be performed to recommend the best insights, using the Euclidean distance (Equation 1):

$$d ( x , y ) = \sqrt{{\sum }_{i = 1}^{n} {( {x}_{i} - {y}_{i} )}^{2}} \qquad [ Equation 1 ]$$

where xᵢ and yᵢ are attributes in the first and second insights (x, y) and n is the total number of attributes selected by proximity location, as previously defined.

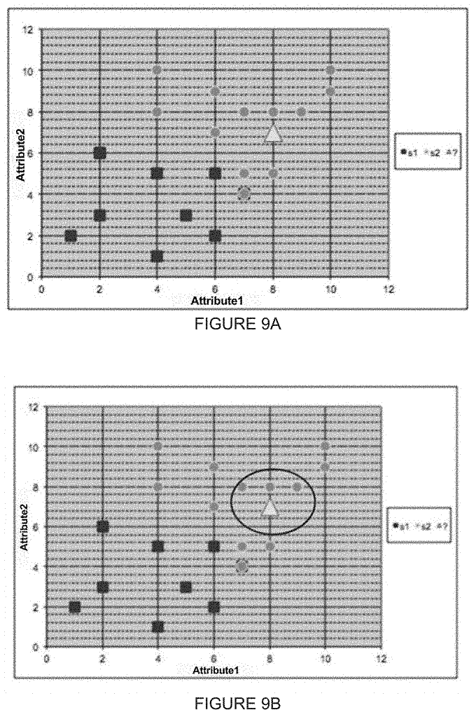

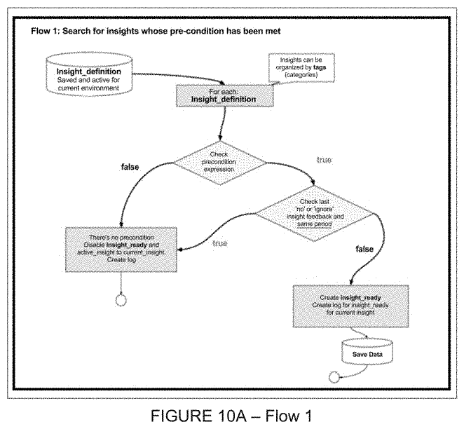

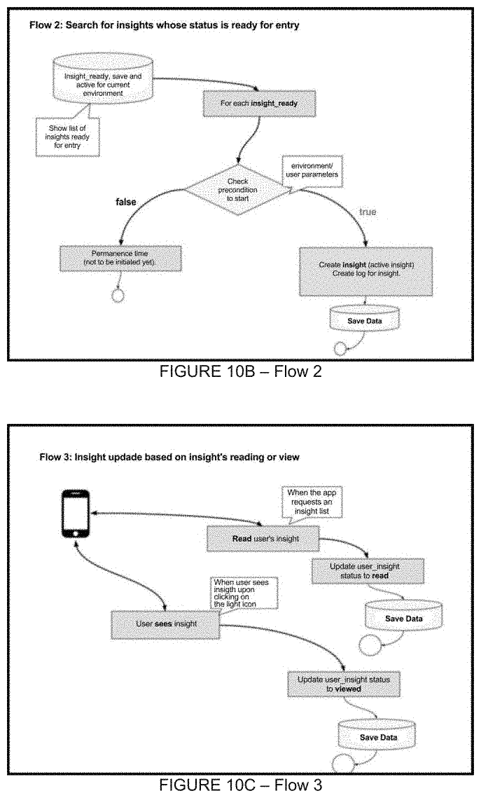

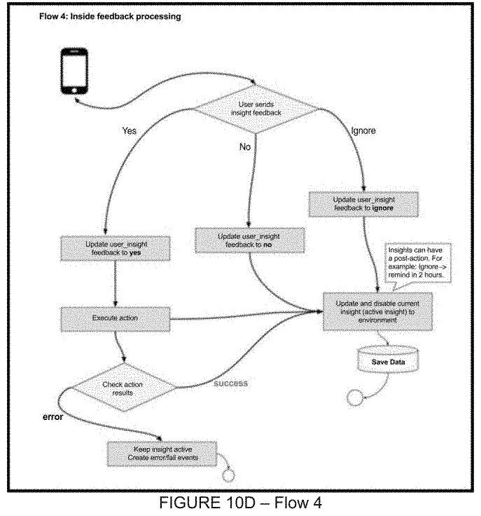

Next, the KNN technique is applied to select the nearest neighbors and thus recommend the nearest insight. FIG. 9A shows a view with two attributes and, in this case, Insight (s2) would be the one selected for being the nearest one; and, FIG. 9B shows the KNN technique being used to select the nearest neighbor and, thus, recommend the nearest insight, which, in this case, would be Insight (s2).

As for its industrial applicability, the intelligent environment management process and system based on IA (IoT) technology can be applied in commercial buildings, residential homes, clubs, stadiums, concert halls, shopping malls, churches, hospitals, hotels, banks, restaurants, schools, universities, industrial plants, airports, farms, industrial sheds, patios, boats, cars, trains, planes, helicopters, and elevators, as well as in other types of residences/houses and condominiums.

Different arrangements are possible, both for the objects shown in the drawings or described above and those features and steps not shown or described. Similarly, some features and subcombinations are useful and can be used without reference to other features and subcombinations. Embodiments of the invention have been described for purposes of illustration and not restriction, and alternative embodiments will be apparent to readers of this disclosure. Accordingly, the present invention is not limited to the embodiments described above or depicted in the drawings, and numerous embodiments and modifications can be made without departing from the scope of the claims below.

### GLOSSARY

User's level of adherence or similar: user's level of comfort in a given environment. Also known as recommendation and commonly referred to by English speakers as ‘matching’;

Environment level of adherence or similar: level of comfort provided by the environment to present users. Also known as recommendation and commonly referred to by English speakers as ‘matching’;

Data collection agent: software installed on the IoT station for reading/action, data preprocessing and transmission.

Environments: commercial and residential buildings, clubs, stadiums, concert premises, shopping malls, churches, hospitals, hotels, banks, restaurants, data processing and transmission;

Billing: account;

IoT Station: Station where data are collected, preprocessed and transmitted, based on IoT, sensors, remote control, and other devices.

Feedback: answers provided by users based on their insight;

Insights: tips and/or recommendations;

KNN: K Nearest Neighbor;

NLP: Natural Language Processing (NLP);

SET POINT: desired analog value;

SVM: Support Vector Machine

1.-13. (canceled)

14. PROCESS Intelligent environment management, which aims to find the levels of user and environment adherence and use them to make set point adjustments and interact with the users; whereas said process comprising the steps of:
Calculate the dynamic user and environment profiles using AI techniques, collecting data from the environment through sensors and user data through registrations and interaction with the system,
Calculate the user and environment adherence levels.
Acting on the system to improve adherence levels, deliver insights, graphic interface built with graphical elements with results, and interact with the user, restarting the process whenever there is a new comfort adjustment request, recalculating the dynamic user and environment profiles, and so on.

15. PROCESS according to claim 14, characterized in that AI techniques include the application of strategies, such as Decision Tree, SVM, KNN, Random Forests, Regression Techniques, Genetic Algorithms, Bioinspired Techniques, Artificial Neural Networks, Fuzzy Logic, and NLP techniques to generate artificial intelligence models (AIMs).

16. PROCESS according to claim 14, characterized in that the user adherence level and the environment adherence level are calculated using data from the Registration Process, the Environment Data Collection Process, and the External Data Collection Process, in addition to user feedback in relation to received insights, the environment's comfort use profile, and user preferences as registered during the registration process.

17. PROCESS according to claim 14, characterized in that the environment is parameterized and classified according to users' adherence level preferences, generating graphic scales indicating the environment's parameterization and classification, and encouraging interaction between the user and the environment.

18. SYSTEM Intelligent environment management, which, along with the ENVIRONMENTAL ADHESION LEVEL MIA AND USERS WITH DYNAMIC PROFILES, calculates the user and environment adherence levels and uses them to make setpoint adjustments and interact with the users; whereas the system comprising:
A data collection agent configured to collect data from sensors located in the environment to transmit them to the cloud.
A cloud data processor configured to process the dynamic user and environment profile calculations using AI,
A cloud data processor configured to process the user and environment adherence level calculations.
An actuator configured to adjust the system's setpoint so as to find the best adherence level for both users and environments.
A user interface configured to interact through a dashboard accessed through the web to request adjustments, send commands, view the status of equipment and systems, and receive insights with visualization of results from images, graphics, text, and voice according to user-defined parameterization, and also an interaction system through APP Mobile application, installed on users' smartphones from cloud stores, such as PlayStore and AppleStore, for requesting adjustments, sending commands, viewing equipment status and systems and receiving insights with visualization of results from images, graphics, text, and voice according to user-defined parameterization.

19. SYSTEM according to claim 18, characterized in that the user interface executes commands to turn air conditioning and lighting on and off and send a temperature SETPOINT to air conditioning equipment, all of which can be remotely executed manually by the user, automatically through ON/OFF hourly programming, or as a result of the AIMS.

20. SYSTEM according to claim 18, characterized in that the data collection agent is installed in an IoT station and configured to collect, prepare, pre-process, and filter local sensing data for transmission to the cloud in real time, through discrete signals, in current, voltage, wireless, WiFi, local physical data network, data input by the user through cell phones, wearables, speakers, and home assistants, computers, laptops, tablets, and so on.
